(19) United States
(12) Patent Application Publication
(10) Pub. No.: US 2026/0228834 A1
(43) Pub. Date: Aug. 6, 2026

(54) METHOD AND SYSTEM FOR ANALYZING TRANSACTION RECORD FILES

(71) Applicant: JPMorgan Chase Bank, N.A., New York, NY (US)

(72) Inventors: Karthik VASANA, Hyderabad (IN); Santoshkumar RACONDA, Hyderabad (IN); Kishan KULKARNI, Hyderabad (IN); Anumukonda CHANDRA MOULIKA, Hyderabad (IN); Braja Sundar DAS, Hyderabad (IN); Uma KODUKULLA, Hyderabad (IN); Swetha BHALLAMUDI, Hyderabad (IN); Kalpana THATAVARTHI, Hyderabad (IN); Pooja B SODHA, Hyderabad (IN)

(73) Assignee: JPMorgan Chase Bank, N.A., New York, NY (US)

(21) Appl. No.: 19/086,925

(22) Filed: Mar. 21, 2025

(30) Foreign Application Priority Data
Feb. 5, 2025 (IN) 202511009475

(51) Int. Cl. G06Q 40/12; G06F 16/11

(52) U.S. Cl. CPC G06Q 40/12; G06F 16/116

(57) ABSTRACT

A method and system for analyzing transaction record files are disclosed. The method includes receiving, by at least one processor, at least one transaction record file in a first format from at least one source. The method also includes segmenting, by the at least one processor, the received at least one transaction record file into a plurality of segmented files in a second format. The method also includes analyzing, by the at least one processor using at least one step function from among a plurality of step functions, the plurality of segmented files. The method also includes aggregating, by the at least one processor, the analyzed plurality of the segmented files into an aggregated file. Thereafter, the method also includes converting, by the at least one processor, the aggregated file into the first format.

### CROSS-REFERENCE TO RELATED APPLICATIONS

This application claims priority benefit from Indian Application No. 202511009475, filed on Feb. 5, 2025, in the India Patent Office, which is hereby incorporated by reference in its entirety.

### FIELD OF THE DISCLOSURE

This technology generally relates to financial transactions processing, and more particularly relates to a method and system for analyzing transaction record files.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In many industries, large volumes of data are generated daily from various sources and in diverse formats. Financial institutions, for instance, often receive transaction records in a standardized format from multiple sources of records (SORs), such as customer profiles, account utilities, and transaction histories. This data must be consolidated, processed, and transformed to produce meaningful reports, monitor compliance, and support decision-making. Due to the high volume and complexity of the data, achieving these tasks within a short processing window, or within a Service Level Agreement (SLA), presents significant technical challenges.

The traditional data processing systems often rely on on-premises infrastructure that requires significant maintenance, offers limited scalability, and struggles to process massive data volumes within the required SLA. Furthermore, many of these systems lack the concurrency and flexibility needed to efficiently process data in parallel, thereby leading to delays and increased costs. The data is often reformatted and analyzed in a stepwise and sequential manner, which slows down the workflow and introduces potential points of failure. As organizations face increasing demands for faster and more reliable data processing system, these limitations have driven the need for a more agile and scalable solution.

In recent years, cloud-based, serverless computing solutions have emerged as a promising alternative. Such solutions allow organizations to leverage highly scalable and cost-effective infrastructure while offloading maintenance and operational responsibilities to cloud providers. Serverless architectures, such as those offered by various vendors, enable organizations to process data in parallel, achieve high concurrency, and optimize cost. However, designing an architecture that fully capitalizes on these serverless services while meeting high SLA demands, handling multiple input file formats, and processing data with state remembrance capabilities still require careful planning and technical innovation.

Hence, in view of these and other existing limitations, there arises an imperative need to provide an efficient solution to overcome the above-mentioned limitations and to provide a method and system for efficiently analyzing the transaction record files.

### SUMMARY

The present disclosure, through one or more of its various aspects, embodiments, and/or specific features or sub-components, provides, inter alias, various systems, servers, devices, methods, media, programs, platforms for analyzing transaction record files.

According to an aspect of the present disclosure, a method for analyzing transaction record files is disclosed. The method is implemented by at least one processor. The method includes receiving, by the at least one processor, at least one transaction record file in a first format from at least one source. The method also includes segmenting, by the at least one processor, the received at least one transaction record file into a plurality of segmented files in a second format. The method also includes analyzing, by the at least one processor using at least one step function from among a plurality of step functions, the plurality of segmented files. The method also includes aggregating, by the at least one processor, the analyzed plurality of the segmented files into an aggregated file. Thereafter, the method also includes converting, by the at least one processor, the aggregated file into the first format.

In accordance with an exemplary embodiment, the first format of the transaction record file may be a parquet format.

In accordance with an exemplary embodiment, the second format of the plurality of segmented files may be a javascript object notation format.

In accordance with an exemplary embodiment, the at least one step function may include retrieving a set of data from a plurality of sources of records, wherein each source of records may be selected from a group that includes an application programming interface (API) call, a database call, and a file system request.

In accordance with an exemplary embodiment, the set of data may include at least one from among a customer profile, a customer summary utility, an account utility, and account treatment details.

In accordance with an exemplary embodiment, each step function included in the plurality of step functions may be executed concurrently.

In accordance with an exemplary embodiment, the method for analyzing transaction record files may further include using serverless services.

According to another aspect of the present disclosure, a computing device configured to implement an execution of a method for analyzing transaction record files is disclosed. The computing device may include a processor; a memory storing instructions; and a communication interface coupled to each of the processor and the memory. The processor may be programmed to cooperate with the instructions to perform operations including receiving at least one transaction record file in a first format from at least one source; segmenting the received at least one transaction record file into a plurality of segmented files in a second format; analyzing, using at least one step function from among a plurality of step functions, the plurality of segmented files; aggregating the analyzed plurality of the segmented files into an aggregated file; and converting the aggregated file into the first format.

In accordance with an exemplary embodiment, the first format of the transaction record file may be a parquet format.

In accordance with an exemplary embodiment, the second format of the plurality of segmented files may be a javascript object notation format.

In accordance with an exemplary embodiment, the at least one step function may include retrieving a set of data from a plurality of sources of records, wherein each source of records may be selected from a group that includes an API call, a database call, and a file system request.

In accordance with an exemplary embodiment, the set of data may include at least one from among a customer profile, a customer summary utility, an account utility, and account treatment details.

In accordance with an exemplary embodiment, each step function included in the plurality of step functions may be executed concurrently.

In accordance with an exemplary embodiment, the operations may further include using serverless services.

According to yet another aspect of the present disclosure, a non-transitory computer-readable storage medium storing instructions for analyzing transaction record files is disclosed. The instructions include executable code which, when executed by a processor, may cause the processor to perform operations including receiving at least one transaction record file in a first format from at least one source; segmenting the received at least one transaction record file into a plurality of segmented files in a second format; analyzing, using at least one step function from among a plurality of step functions, the plurality of segmented files; aggregating the analyzed plurality of the segmented files into an aggregated file; and converting the aggregated file into the first format.

In accordance with an exemplary embodiment, the first format of the transaction record file may be a parquet format.

In accordance with an exemplary embodiment, the second format of the plurality of segmented files may be a javascript object notation format.

In accordance with an exemplary embodiment, the at least one step function may include retrieving a set of data from a plurality of sources of records, wherein each source of records may be selected from a group that includes an API call, a database call, and a file system request.

In accordance with an exemplary embodiment, the set of data may include at least one from among a customer profile, a customer summary utility, an account utility, and account treatment details.

In accordance with an exemplary embodiment, each step function included in the plurality of step functions may be executed concurrently.

In accordance with an exemplary embodiment, the operations may further include using serverless services.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system for analyzing transaction record files, in accordance with an exemplary embodiment of the present disclosure.

FIG. 2 illustrates an exemplary diagram of a network environment for analyzing transaction record files, in accordance with an exemplary embodiment of the present disclosure.

FIG. 3 illustrates an exemplary system for analyzing transaction record files, in accordance with an exemplary embodiment of the present disclosure.

FIG. 4 illustrates an exemplary method flow diagram for analyzing transaction record files, in accordance with an exemplary embodiment of the present disclosure.

FIG. 5 illustrates an architecture of a system for analyzing transaction record files, in accordance with an exemplary embodiment of the present disclosure.

FIG. 6 illustrates an exemplary architecture of a system for analyzing transaction record files in a single region, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” may include any and all combinations and arrangements of one or more of the associated listed items. Also, as used herein, the phrase “at least one” means and may include “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures may include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples may include executable code that, when executed by one or more processors, causes the processors to carry out steps necessary to implement the methods of the examples of this technology that are described and illustrated herein.

Currently, there is a notable absence of systems or products that offer effective and precise solutions which address the challenge of meeting service level agreement (SLA) and high-volume batch processing of transaction record activity. In order to perform an operation, the processing requires reading input files, consolidating the data from different sources of records and furnishing the final files with complete data is a complex task during handling the high-volume data. Existing solutions typically lack the processing of such high-volume transactions data associated with the individual's buying, offering, and lending activity. As a result, there remains a significant gap for analyzing transaction record files associated with individual's or user's financial activity.

The present disclosure solves the aforementioned problems by providing a method and system for analyzing transaction record files. In the present disclosure, at first, the system receives the transaction record file in a first format. Further, the system segments the received transaction record file into a plurality of segmented files in a second format. Further, the system analyzes the plurality of segmented files via at least one step function. Further, the system aggregates the analyzed plurality of the segmented files into an aggregated file. Thereafter, the system converts the aggregated file into the first format.

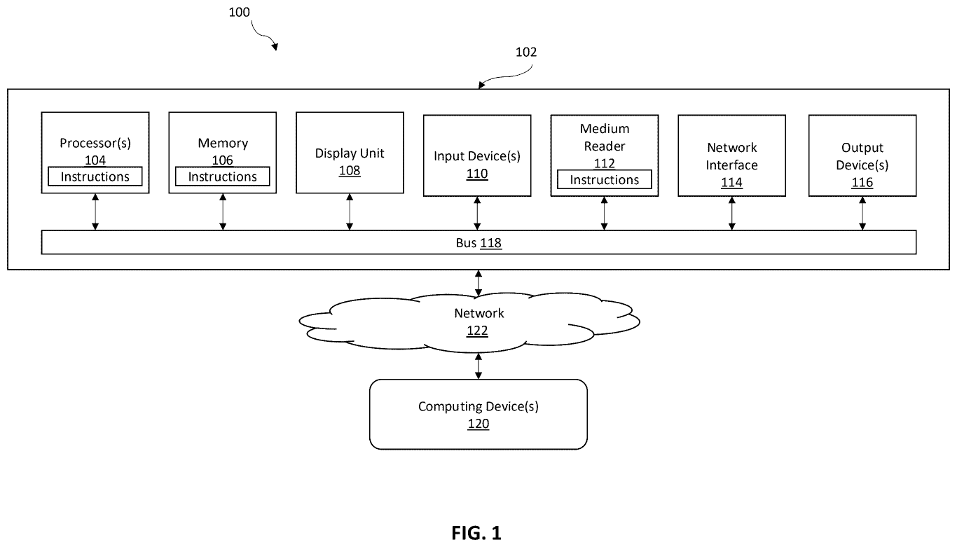

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such a cloud-based computing environment.

In a networked deployment, the computer system 102 may operate in the capacity of a server or as a client-user computer in a server-client network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that may include discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for analyzing transaction record files.

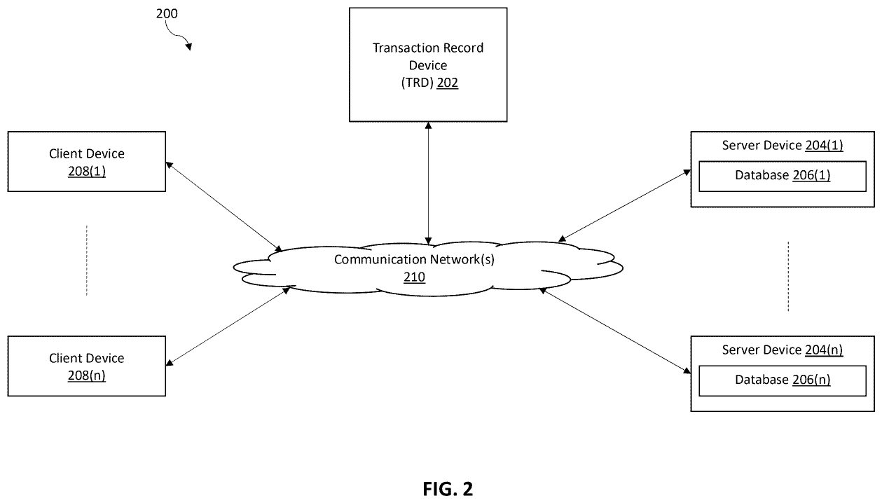

Referring to FIG. 2, a schematic of an exemplary network environment 200 for analyzing transaction record files is illustrated. In an exemplary embodiment, the method is executable on any networked computer platform, such as, for example, a personal computer (PC).

The method for analyzing transaction record files may be executed by a transaction record device (TRD) 202. The TRD 202 may be the same or similar to the computer system 102 as described with respect to FIG. 1. The TRD 202 may store one or more applications that may include executable instructions that, when executed by the TRD 202, cause the TRD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the TRD 202 itself, may be located in the virtual server(s) running in a cloud-based computing environment rather than being tied to one or more specific physical network computing devices. Also, the application(s) may be running in one or more virtual machines (VMs) executing on the TRD 202. Additionally, in one or more embodiments of this technology, virtual machine(s) running on the TRD 202 may be managed or supervised by a hypervisor.

In the network environment 200 of FIG. 2, the TRD 202 is coupled to a plurality of server devices 204(1)-204(n) that hosts a plurality of databases 206(1)-206(n), and also to a plurality of client devices 208(1)-208(n) via communication network(s) 210. A communication interface of the TRD 202, such as the network interface 114 of the computer system 102 of FIG. 1, operatively couples and communicates between the TRD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TRD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and TRDs that efficiently implement the method for analyzing transaction record files.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The TRD 202 may be a standalone device or integrated with one or more other devices or apparatuses, such as one or more of the server devices 204(1)-204(n), for example. In one particular example, the TRD 202 may include or be hosted by one of the server devices 204(1)-204(n), and other arrangements are also possible. Moreover, one or more of the devices of the TRD 202 may be in the same or a different communication network including one or more public, private, or cloud-based networks, for example.

The plurality of server devices 204(1)-204(n) may be the same or similar to the computer system 102 or the computing device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the TRD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data related to transactions and records of upstream and downstream sources.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computing device 120 as described with respect to FIG. 1, including any features or combination of features described with respect thereto. For example, the client devices 208(1)-208(n) in this example may include any type of computing device that can interact with the TRD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the TRD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the TRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the TRD 202, the server devices 204(1)-204(n), or the client devices 208(1)-208(n), for example, may be configured to operate as virtual instances on the same physical machine. In other words, one or more of the TRD 202, the server devices 204(1)-204(n), or the client devices 208(1)-208(n) may operate on the same physical device rather than as separate devices communicating through communication network(s) 210. Additionally, there may be more or fewer TRDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

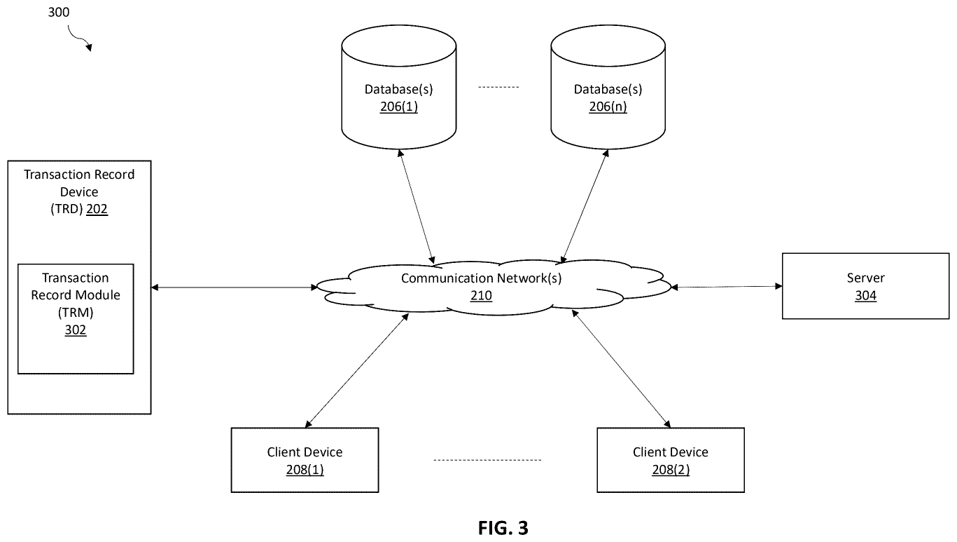

FIG. 3 illustrates a system diagram for implementing a method for analyzing transaction record files, in accordance with an exemplary embodiment.

As illustrated in FIG. 3, the system 300 may include a TRD 202 within which a transaction record module (TRM) 302 is embedded, a server 304, a database(s) 206(1) . . . 206(n), a plurality of client devices 208(1) . . . 208(2), and a communication network(s) 210.

According to exemplary embodiments, the TRD 202 including the TRM 302 may be connected to the server 304, and the database(s) 206(1) . . . 206(n) via the communication network(s) 210, but the disclosure is not limited thereto. The TRD 202 may also be connected to the plurality of client devices 208(1) . . . 208(2) via the communication network 210, but the disclosure is not limited thereto. The database(s) 206(1) . . . 206(n) may include a rule database.

In an embodiment, the TRD 202 is described and shown in FIG. 3 as including the TRM 302, although it may include other rules, policies, modules, databases, or applications, for example. As will be described below, the TRM 302 is configured to implement a method to analyze transaction record files.

An exemplary system 300 for implementing a mechanism for analyzing transaction record files by utilizing the network environment of FIG. 2 is shown as being executed in FIG. 3. Specifically, a first client device 208(1) and a second client device 208(2) are illustrated as being in communication with the TRD 202. In this regard, the first client device 208(1) and the second client device 208(2) may be “clients” of the TRD 202 and are described herein as such. Nevertheless, it is to be known and understood that the first client device 208(1) and/or the second client device 208(2) need not necessarily be “clients” of the TRD 202, or any entity described in association therewith herein. Any additional or alternative relationship may exist between either or both of the first client device 208(1) and the second client device 208(2) and the TRD 202, or no relationship may exist.

Further, the TRD 202 is illustrated as being able to access one or more databases 206(1) . . . 206(n). The TRM 302 may be configured to access these repositories/databases for implementing a method to analyze transaction record files. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the TRD 202 via broadband or cellular communication. These embodiments are merely exemplary and are not limiting or exhaustive.

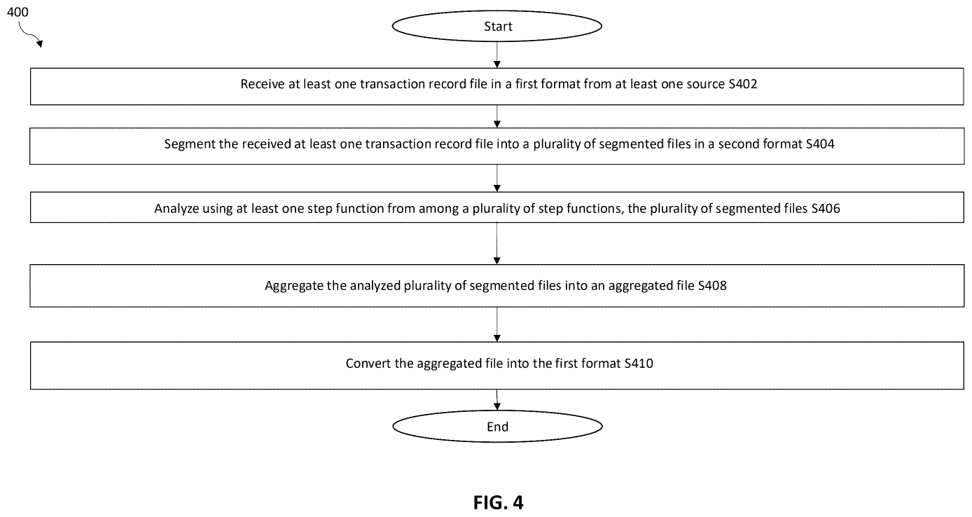

Referring to FIG. 4, an exemplary method 400 is shown for analyzing transaction record files, in accordance with an exemplary implementation.

As shown in FIG. 4, the method 400 begins following a need for analyzing transaction record files in an effective way for addressing an individual's financial activity. The method 400 is implemented by at least one processor 104.

At step S402, the method 400 may include receiving, by the at least one processor 104, at least one transaction record file of a first format from at least one source.

In an exemplary implementation, the “transaction record file” herein may refer to a data file containing a transaction-related information, which may include financial transactions, customer interactions, account details, and/or other business-related data. The transaction record file may be received initially in a specific format, referred to as the “first format.” For example, the first format of the transaction record file may be a parquet format, which is a columnar storage file format commonly used for handling large volumes of data efficiently, particularly in big data and cloud environments.

In an exemplary implementation, the at least one source from where the transaction record file is received may include any system of record (SOR) that stores or generates transactional data. Examples of the at least one source may include databases within a cloud storage environment, data lakes, application program interfaces (APIs) from transactional systems, or other external data storage or retrieval systems. For example, a banking system may generate a transaction record file in the parquet format, which may contain detailed information about customer transactions. The processor 104 may be configured to retrieve this file directly from the banking system's database or through an API that interfaces with the source database.

In another example, the transaction record file may be received from a financial data warehouse that collects and stores aggregated data from multiple operational systems. Here, the processor 104 may establish a secure communication channel with the financial data warehouse using the communication interface and retrieve the transaction record file as soon as it becomes available. This retrieval process may be triggered automatically or may be based on specific conditions, such as the completion of a data batch or the receipt of a new transaction record or any other such conditions.

At step S404, the method 400 may include segmenting, by the at least one processor 104, the received transaction record file into a plurality of segmented files in a second format.

After the transaction record file in the first format (e.g., parquet format) is received from the at least one source, the processor 104 may initiate a segmentation process to divide the received transaction record file into smaller, more manageable data segments. The segmentation is performed to enable parallel processing of the data, which improves efficiency, reduces processing time, and allows the system to handle large volumes of data more effectively.

During segmentation, the processor 104 may convert each segment of the transaction record file from the first format (e.g., parquet format) to a second format, such as JavaScript Object Notation (JSON). It will be appreciated by the person skilled in the art that the JSON may be selected as the second format because it is widely supported, lightweight, and ideal for use in data exchanges and serverless processing environments, such as AWS Lambda and other cloud-based services. Further, by converting to JSON, each segment becomes compatible with various cloud services and can be processed independently within a distributed, serverless architecture.

For example, if the received transaction record file contains thousands of rows of financial transactions, each row representing an individual transaction, the processor 104 may segment this file by dividing the rows into chunks of a predefined chunk size, such as 500 transactions per segment. Each segment is then converted to JSON format, resulting in multiple JSON files, each containing a subset of the original data. The segmentation and conversion facilitate efficient processing, as each JSON file can be handled by separate instances of the processing functions in subsequent steps.

At step S406, the method 400 may include analyzing, by the at least one processor 104 using at least one step function from among a plurality of step functions, the plurality of segmented files.

In an embodiment, after the transaction record file is segmented and converted into the second format, each segmented file may be analyzed individually to extract valuable insights or perform specific data transformations. The analysis is carried out using the at least one step function, which allows the processor 104 to manage each analysis operation as part of an orchestrated workflow. The at least one step function from among the plurality of step functions enables sequential or parallel processing of each segmented file, making the system highly efficient and scalable for handling large volumes of data.

In an embodiment, each of the at least one step function from among the plurality of step functions may be configured to retrieve and process data from various sources of records (SORs), such as customer profiles, account utilities, and transaction histories, through API calls, database queries, or file system requests. For example, if the plurality of segmented files contains partial customer transaction data, the step functions may be tasked with retrieving additional data from relevant SORs, such as customer account details or transaction categorizations, to enrich the segmented files with supplemental information.

In an exemplary implementation, the analysis conducted by each step function may involve validating and transforming the data within each segment. For example, if the segmented file includes a list of transactions, then each step function may analyze each transaction to identify patterns, calculate summary statistics, and/or perform data quality checks such as identifying missing or anomalous values.

In another example, the analysis may include performing calculations or transformations specific to each segment's data attributes. For example, if the segmented file represents customer transactions for a specific time period, the step functions might calculate the total transaction amount, average transaction value, or identify high-value transactions within that segment. By analyzing each segment independently, the system can handle large datasets in parallel, significantly reducing processing time while maintaining consistency and reliability.

At step S408, the method 400 may include aggregating, by the at least one processor 104, the analyzed plurality of segmented files into an aggregated file.

In an embodiment, after each segmented file in the second format (e.g., JSON) has been individually analyzed in parallel, the processor 104 may consolidate the results from all analyzed segments into a single, comprehensive aggregated file.

In an embodiment, during aggregation, the processor 104 may collect the results from each analyzed segment and combine them into a structured format that mirrors the original transaction record file. For example, if each analyzed segment contains transaction records processed and enriched with additional data, the processor 104 may compile these enriched records into a single aggregated file. For example, if the segmented files represent transactional data grouped by customer regions, with each segment containing the analysis for a specific region, the processor 104 may aggregate these regional segments to create a single file containing the analyzed transactions across all regions. This aggregated file may provide a complete dataset, allowing users to view a unified report of transactions at an organizational level, rather than region by region.

In another example, the aggregation process may involve merging data points that were separately analyzed across segments, such as totals, averages, or other summary statistics computed during analysis. For example, if each segment includes transaction totals per customer, the processor 104 may aggregate these individual totals to produce an overall transaction total, average spending per customer, or other cumulative metrics. This aggregated information may then be used for reporting, compliance, and/or business intelligence purposes.

At step S410, the method 400 may include converting, by the at least one processor 104, the aggregated file into the first format of the transaction record file.

In an embodiment, after aggregation, the data is typically in a format such as JSON, which was used for the segmented files to facilitate analysis and processing. However, for final storage, transfer, or compatibility with other systems, the aggregated file may need to be converted back into its original format, such as the first format.

For example, if the aggregated file contains analyzed transaction data across different customer segments, converting it back to parquet format allows the file to be easily stored and accessed within a Hadoop-based data lake or other big data environment that supports parquet format.

In another example, if the aggregated file is intended for batch export to an external analytics system that requires parquet format for ingestion, the processor 104 will convert the JSON data back to parquet format before initiating the transfer.

In an exemplary implementation, the method 400 may be implemented by using a design and a technical architecture of serverless services from Amazon Web Service (AWS), which ensures cost optimization while achieving the benefits in delivering the functional aspects of the method 400. As AWS serverless services are used, maintaining the infrastructure is taken care of by AWS. This technical architecture is cost effective, reliable and scalable.

In an exemplary implementation, the method 400 may execute each step function included in the plurality of step functions concurrently. The data from various sources of records (SORs) may be divided into chunks and allowed to be processed via parallel step functions which have state remembrance capability. Each step function may retrieve the data in chunks from an SOR (whether it is an API call, database call etc.) and work with multi-threading to process bulk requests at once.

Thereafter, the method 400 terminates.

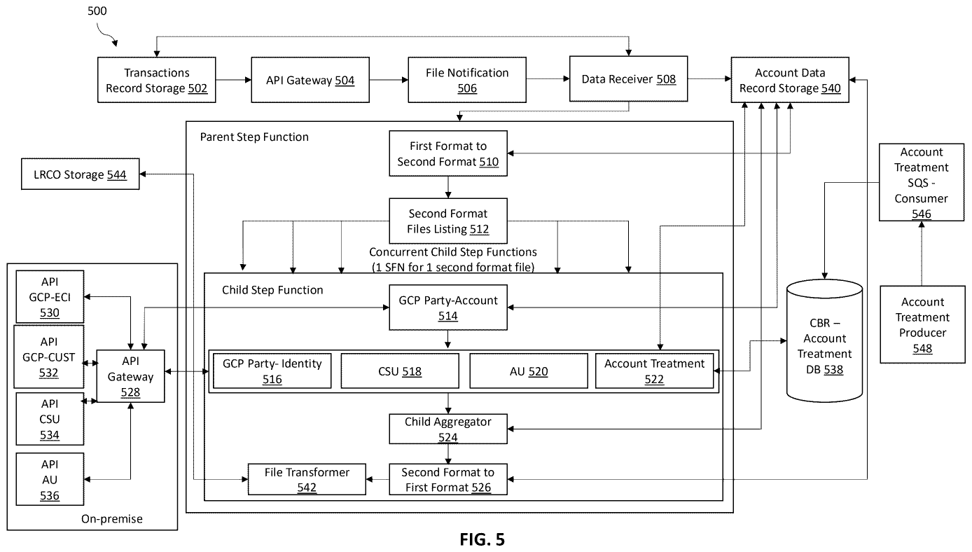

FIG. 5 illustrates an architecture of a system 500 for analyzing transaction record files, in accordance with an exemplary implementation. As illustrated in FIG. 5, the system 500 may include a transactions record storage 502, an API gateway 504, a file notification module 506, a data receiver module 508, a first format to second format conversion module 510, a second format files listing module 512, a global customer profile (GCP) party account module 514, a GCP party identity module 516, a customer summary utility (CSU) module 518, an account utility (AU) module 520, an account treatment module 522, a child aggregator 524, a second format to first format conversion module 526, an API gateway 528, an API GCP-ECI (enterprise party identifier) module 530, an API GCP-CUST module 532, an API CSU module 534, an API AU module 536, a credit bureau reporting (CBR)—Account Treatment database (DB) 538, an account data record storage 540, a file transformer module 542, a Legal and Regulatory control operations (LRCO) Storage 544, an account treatment simple queue service (SQS)—Consumer 546 and an account treatment producer 548. The account treatment consumer 546 based on the trigger account treatment producer 548 may consume and may write the data into CBR—Account Treatment DB 538 which is used to aggregate the data by one of the lambdas in the workflow. In an exemplary implementation, there is an upstream system which may trigger any bankruptcy, deceased or disputes information on any given account in the form of events through SNS (Topic)—SQS (Messaging Queue) integration. SNS is a topic where the messages may be published by the producer and an SQS queue may subscribe to the topic which is listened by the account treatment consumer application. This approach of using SNS-SQS integration may help in having multiple independent consumers/subscribers to the same topic and also having de-coupled producer and consumer applications

In an exemplary implementation, the system 500 may operate in a serverless environment.

In an embodiment, the transactions record storage 502 serves as the primary repository for transaction data files in their original format, such as a parquet format. This storage may hold data related to user profiles, lender details, transaction histories, and patterns, and may include storage solutions like cloud storage, local servers, or Amazon S3 buckets. When new transaction files are ready for processing, the transactions record storage 502 may send a trigger to the API gateway 504. The API gateway 504, configured within the serverless framework, may authorize the incoming request through mechanisms like Lambda authorizers, verifying credentials via authentication tokens or identity management policies before proceeding.

In an embodiment, once authorized, the file notification module 506 may receive the trigger from the API gateway 504 and forward it to the data receiver module 508. The data receiver module 508 may access the path to the transaction files in the transaction record storage 502 and may retrieve the files for further processing. These retrieved files may then be stored temporarily in the account data record storage 540 and may trigger a parent step function to initiate the processing workflow. The parent step function's outputs may be recorded in the account data record storage 540, providing a checkpoint at each stage of the processing sequence.

In an embodiment, the first format to second format conversion module 510 may then convert the transaction record file from the first format (such as parquet format) to a second format (typically in a JSON). This JSON conversion enables easier segmentation and compatibility with other processing functions. The converted files may be stored in the account data record storage 540, and child step functions may be triggered for further processing on the converted JSON file.

In an embodiment, the second format files listing module 512 may organize the JSON files into segmented units, enabling each segment to be processed independently. Each segmented JSON file may undergo analysis through a dedicated child step function. This segmentation and concurrent child step function processing may allow for optimized handling of large datasets. For each segmented file, a child step function may interact with various child modules to retrieve relevant data from multiple systems of records (SORs) to enrich the data. These child modules may include the GCP party account module 514, the GCP party identity module 516, the customer summary utility (CSU) module 518, the account utility (AU) module 520, and the account treatment module 522. These child modules may fetch detailed information like customer identities, addresses, restriction codes, and credit bureau records by interfacing with specific APIs through the API gateway 528.

In an embodiment, the child modules may connect through APIs such as

API GCP-ECI 530, API GCP-CUST 532, API CSU 534, and API AU 536, which are accessed via API gateway 528 to retrieve enterprise identifiers, consumer profiles, addresses, and other critical data attributes. The account treatment module 522 may interact directly with the CBR-Account Treatment DB 538 to access records on bankruptcy, disputes, and other account treatment data associated with each transaction.

In an embodiment, following the retrieval and processing of data within each segment, the child aggregator module 524 may combine the analyzed segments back into a unified file, consolidating all the enriched data from the child step functions. This combined file may be then stored in the account data record storage 540 and passed to the second format to first format conversion module 526, which converts the aggregated JSON file back to the original parquet format.

In an embodiment, the file transformer module 542 may finally process the re-converted parquet format file, preparing it for final storage or downstream applications. The processed file may be then stored in LRCO Storage 544 for long-term retention or further utilization.

This architecture offers a flexible and robust solution for analyzing large transaction record files. By leveraging a serverless design, the system may scale dynamically to handle high data volumes, segment data for efficient parallel processing, and perform data enrichment through modular API integrations. The use of child step functions may provide enhanced fault tolerance, enabling retries and state management across multi-step workflows. This architecture supports deployment in cloud, microservice, and multi-availability zone environments, making it adaptable to different operational requirements.

It will be appreciated by the person skilled in the art that the disclosed method offers a full-circle, adaptable, and intelligent solution for implementing a method for analyzing transaction record files. The present disclosure may use a serverless architecture. The present disclosure may handle high-volume data by segmenting it into small chunks to process them effectively and parallelly. Further, the present disclosure may be implemented in a monolithic, microservice and different types of cloud network environment. Furthermore, the present disclosure may be implemented in a multi-availability zones network environment.

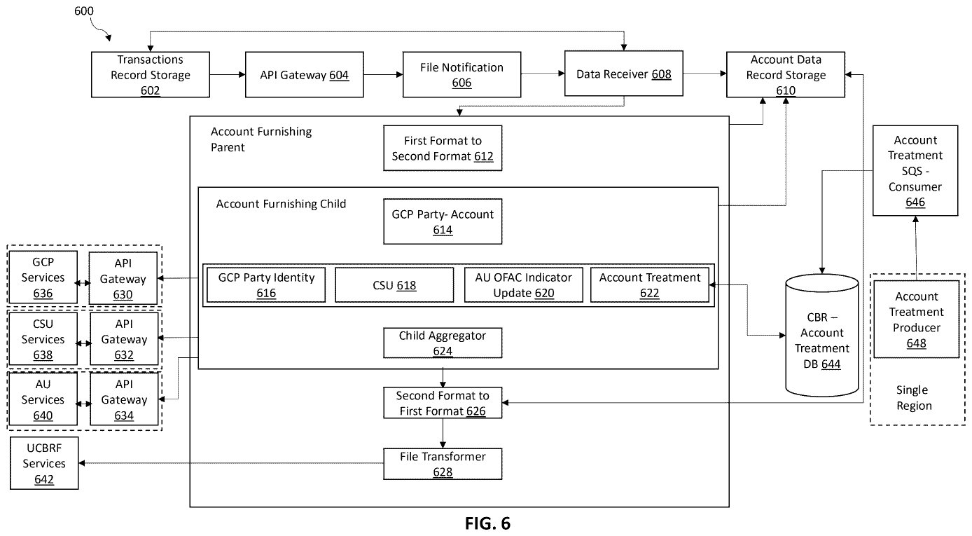

FIG. 6 illustrates an exemplary architecture of a system 600 for analyzing transaction record files in a single region, in accordance with an exemplary implementation. As illustrated in FIG. 6, the system 600 may include a transactions record storage 602, an API gateway 604, a file notification module 606, a data receiver module 608, an account data record storage 610, a first format to second format conversion module 612, a global customer profile (GCP) party account module 614, a GCP party identity module 616, a customer summary utility (CSU) module 618, an account utility (AU) office of foreign asset control (OFAC) indicator update module 620, an account treatment module 622, a child aggregator 624, a second format to first format conversion module 626, a file transformer module 628, an API gateway 630, an API gateway 632, an API gateway 634, a GCP services module 636, an CSU services module 638, an AU services module 640, a united credit bureau reporting facility (UCBRF) services 642, a CBR—account treatment DB 644, an account treatment simple queue service (SQS)—Consumer 646 and an account treatment producer 648 in a single region.

In an embodiment, the transactions record storage 602 may be the initial storage location for incoming transaction record files, which are stored in a first format, such as a parquet format. This storage may include various types of storage solutions, including cloud storage, local servers, or Amazon S3 buckets. The transaction record storage 602 may hold data such as repayment simulations, account management details, and account balances, often aggregated from various sources. When a new transaction file, like a parquet format file for a financial transaction, is ready for processing, the transaction record storage 602 may send a trigger request to the API gateway 604. This gateway, part of the serverless architecture, may act as a secure entry point for processing requests.

In an embodiment, the API gateway 604 may first authorize the trigger request to ensure security. This authorization is managed through a Lambda authorizer, which uses various authentication mechanisms like access tokens, SAML, or identity access management policies. Once the trigger request is authorized, the API gateway 604 may forward the request to the file notification module 606.

In an embodiment, the file notification module 606 may receive the trigger and pass it to the data receiver module 608. The data receiver module 608 may retrieve the specified files from transaction record storage 602 and temporarily may store them in account data record storage 610 for further processing. This module may then trigger a parent step function to initiate the processing workflow. Each stage of the parent step function's output may be stored in the account data record storage 610, creating a record of each processing step.

In an embodiment, the first format to second format conversion module 612 may then convert the transaction record file from the original format (such as in parquet format) to a second format, which is typically a JSON format, to facilitate easier segmentation and processing. The converted JSON file may then be stored in the account data record storage 610 and child step functions are triggered for further processing on the converted JSON file.

In an embodiment, the child step functions may orchestrate the processing tasks by automating workflows, creating stateful processes, and managing each step in the transaction data analysis. Based on predefined policies and SLAs, multiple child step functions may operate concurrently to handle different parts of the transaction record. The JSON file is segmented into smaller JSON files, and each segment may be processed by a separate child step function, allowing parallel processing and efficient handling of large datasets. For instance, a file containing 1,000,000 transaction records may be split into five segments, each containing 200,000 records, for individual processing.

In an embodiment, each segment may be then analyzed by child step functions through specific modules, including the global customer profile (GCP) party account module 614, the GCP party identity module 616, the customer summary utility (CSU) module 618, the AU OFAC indicator update module 620, and the account treatment module 622. These modules may fetch detailed data from various SORs in parallel. For example, the GCP party account module 614 connects to GCP services module 636 through API gateway 630 to retrieve an enterprise party identifier (ECI). Simultaneously, the GCP party identity module 616 uses API gateway 630 to obtain customer identity information, the CSU module 618 retrieves address data via API gateway 632 and CSU services module 638, and the AU OFAC indicator update module 620 uses API gateway 634 to access restriction code information from AU services module 640. The account treatment module 622 connects to CBR-Account Treatment DB 644 to access credit bureau information, including bankruptcy, dispute, or deceased statuses associated with the ECI.

In an embodiment, following data retrieval and processing by each child module, the account treatment producer 648 and account treatment SQS-Consumer 646 may handle data sequencing and queuing tasks within the single-region deployment.

In an embodiment, after all segments have been processed, the child aggregator module 624 may combine the processed segments into a single, aggregated file, consolidating the enriched data from each segment. This aggregated file may be then stored in the account data record storage 610 and then passed to the second format to first format conversion module 626, where it is converted back from JSON to the original parquet format.

In an embodiment, the final output, now in the parquet format, may be sent to the file transformer module 628 for additional processing and formatting adjustments. Once processed, the transformed parquet file may be transmitted to united credit bureau reporting facility (UCBRF) services 642. This final step may allow reporting facilities to access a comprehensive record of transactions, which may include data from various sources such as “buy now, pay later” transactions, credit history, and loan information, all presented in a unified and accessible format.

It will be appreciated by the person skilled in the art that the disclosed system architecture in FIG. 6 is similarly implemented in a multi-availability zone network environment, which ensures high-availability implementation of the service network of the present disclosure.

The present disclosure provides several advantages, as outlined below. The present disclosure describes a method for analyzing transaction records for a plurality of users. The method facilitates a serverless architecture that supports cost optimization for analyzing and managing the transaction records. This approach effectively handles large volumes of data by segmenting it into small chunks, allowing for the processing of these small chunks via parallel step functions with state remembrance capability. Each step function utilizes multi-threading to process bulk requests simultaneously. Additionally, the present disclosure provides a method for reporting a user's transaction records to a credit bureau reporting facility. The present disclosure also provides a method for operating the process in multiple availability zones, ensuring high availability during any sudden zone inactivity during operation.

Although the present application has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the present application has been described with reference to particular means, materials, and embodiments, the present application is not intended to be limited to the particulars disclosed; rather the present application extends to all functionally equivalent structures, methods, and uses such as are within the scope of the appended claims.

For example, while the computer-readable medium may be described as a single medium, the term “computer-readable medium” may include a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for analyzing transaction record files is disclosed. The instructions include executable code which, when executed by a processor 104, may cause the processor 104 to receive the transaction record file in a first format; segment the received transaction record file into a plurality of segmented files in a second format; analyze, using at least one step function, the plurality of segmented files; aggregate the analyzed plurality of segmented files into an aggregated file; and convert the aggregated file into the first format.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for analyzing transaction record files, the method being implemented by at least one processor, the method comprising:
receiving, by the at least one processor, at least one transaction record file in a first format from at least one source;
segmenting, by the at least one processor, the received at least one transaction record file into a plurality of segmented files in a second format;
analyzing, by the at least one processor using at least one step function from among a plurality of step functions, the plurality of segmented files;
aggregating, by the at least one processor, the analyzed plurality of segmented files into an aggregated file; and
converting, by the at least one processor, the aggregated file into the first format.

2. The method as claimed in claim 1, wherein the first format of the transaction record file is a parquet format.

3. The method as claimed in claim 1, wherein the second format of the plurality of segmented files is a javascript object notation format.

4. The method as claimed in claim 1, wherein the at least one step function includes retrieving a set of data from a plurality of sources of records, wherein each source of records is selected from a group that includes an application programming interface (API) call, a database call, and a file system request.

5. The method as claimed in claim 4, wherein the set of data comprises at least one from among a customer profile, a customer summary utility, an account utility, and account treatment details.

6. The method as claimed in claim 1, wherein each step function included in the plurality of step functions is executed concurrently.

7. The method as claimed in claim 1, further comprising using serverless services.

8. A computing device configured for analyzing transaction record files, the computing device comprising:
a processor;
a memory storing instructions; and
a communication interface coupled to each of the processor and the memory, wherein the processor is programmed to cooperate with the instructions to perform operations comprising:
receiving at least one transaction record file in a first format from at least one source;
segmenting the received at least one transaction record file into a plurality of segmented files in a second format;
analyzing, using at least one step function from among a plurality of step functions, the plurality of segmented files;
aggregating the analyzed plurality of the segmented files into an aggregated file; and
converting the aggregated file into the first format.

9. The computing device as claimed in claim 8, wherein the first format of the transaction record file is a parquet format.

10. The computing device as claimed in claim 8, wherein the second format of the plurality of segmented files is a javascript object notation format.

11. The computing device as claimed in claim 8, wherein the at least one step function includes retrieving a set of data from a plurality of sources of records, wherein each source of records is selected from a group that includes an application programming interface (API) call, a database call, and a file system request.

12. The computing device as claimed in claim 11, wherein the set of data comprises at least one from among a customer profile, a customer summary utility, an account utility, and account treatment details.

13. The computing device as claimed in claim 8, wherein each step function included in the plurality of step functions is executed concurrently.

14. The computing device as claimed in claim 8, wherein the operations further comprise using serverless services.

15. A non-transitory computer readable storage medium storing instructions for analyzing transaction record files, the instructions comprising executable code which, when executed by a processor, causes the processor to perform operations comprising:
receiving at least one transaction record file in a first format from at least one source;
segmenting the received at least one transaction record file into a plurality of segmented files in a second format;
analyzing, using at least one step function from among a plurality of step functions, the plurality of segmented files;
aggregating the analyzed plurality of segmented files into an aggregated file; and
converting the aggregated file into the first format.

16. The storage medium as claimed in claim 15, wherein the first format of the transaction record file is a parquet format.

17. The storage medium as claimed in claim 15, wherein the second format of the plurality of segmented files is a javascript object notation format.

18. The storage medium as claimed in claim 15, wherein the at least one step function includes retrieving a set of data from a plurality of sources of records, wherein each source of records is selected from a group that includes an application programming interface (API) call, a database call, and a file system request.

19. The storage medium as claimed in claim 18, wherein the set of data comprises at least one from among a customer profile, a customer summary utility, an account utility, and account treatment details.

20. The storage medium as claimed in claim 15, wherein each step function included in the plurality of step functions is executed concurrently.
